(19) United States
(12) Patent Application Publication
(10) Pub. No.: US 2012/0265445 A1
(43) Pub. Date: Oct. 18, 2012

(54) STABLE SHOT ILLUMINATION COMPENSATION

(75) Inventors: Linbin Zhang, Danville, CA (US); Wei Liu, San Ramon, CA (US); Yue Wang, Sugar Land, TX (US); Guojian Shan, San Ramon, CA (US)

(73) Assignee: Chevron U.S.A. Inc., San Ramon, CA (US)

(21) Appl. No.: 13/086,032

(22) Filed: Apr. 13, 2011

(51) Int. Cl. G06F 19/00

(52) U.S. Cl. 702/14

(57) ABSTRACT

Various embodiments provide a system and a shot illumination compensation method implemented on a computer system for imaging a subsurface formation. The method includes receiving, by the computer system, seismic data produced by an acoustic energy source and reflected by the subsurface formation; and generating, by the computer system, an image of the subsurface formation based on the seismic data and a spatially varying damping parameter.

### FIELD

The present invention relates generally to imaging rock formations and more specifically to illumination compensation for rock formation imaging.

### BACKGROUND

Seismic surveying is used to evaluate structures of, compositions of, and fluid content of subsurface earth formations. A particular application for seismic surveying is to infer the presence of useful materials, such as petroleum, in the subsurface earth formations. Generally, seismic surveying includes deploying an array of seismic sensors at or near the earth's surface, and deploying a seismic energy source near the sensors also at or near the surface. The seismic energy source is actuated and seismic energy emanates from the source, traveling generally downwardly through the subsurface until it reaches one or more acoustic impedance boundaries in the subsurface. Seismic waves are reflected from the one or more impedance boundaries, whereupon it then travels upwardly until being detected by one or more of the seismic sensors. Structure and stratigraphic composition of the Earth's subsurface is inferred from, among other properties of the detected energy, the travel time of the seismic wave, and the amplitude and phase of the various frequency components of the seismic wave with respect to the energy emanating from the seismic source.

In order to infer the structures of subsurface earth formations from seismic waves measured at the earth's surface from the source/receiver position at the surface, it is necessary to determine the velocity of the various formations through which the seismic wave passes. Velocities of the earth formations can vary both with respect to depth in the earth (vertically), and with respect to geographic position (laterally). Seismic data, however, are recorded only with respect to time. Methods known in the art for estimating velocities of the earth formations both vertically and laterally rely on inferences about the travel path geometry of the seismic wave as it travels from the source to the various receivers deployed at the earth's surface.

In order for images produced from seismic data to correspond accurately to the spatial distribution of subsurface structures and compositional changes in the Earth's subsurface, techniques known generally as “time migration” and “depth migration” are performed on the seismic data. Migration is a process by which reflection events in seismic data are made to correspond in time (time migration) to the reflection times that would occur if seismic data acquisition geometry were identical for every surface position for which an image is produced, and in the case of depth migration, to have such events be located at the depths in the Earth at which they are located. Thus, migration is performed in two general classes of migration process. Time migration is used to cause the reflective events to be positioned at the correct time in the image. Depth migration is used to cause the reflective events to be positioned at the correct depth in the image. Migration techniques are performed either “pre-stack” or “post-stack.” Post stack migration refers to migration techniques that are performed on seismic data for which numbers of individual data recordings (“traces”) are processed and summed to improve seismic signal to noise ratio. Pre-stack migration, by contrast, is performed on individual data recordings. Pre-stack migration typically produces better images. An effective method of pre-stack time migration is disclosed, for example, in Sun, C., Martinez, R., Amplitude preserving 3D pre-stack Kirchhoff time migration for V(z) and VTI media, 72nd Annual International Meeting, Society of Exploration Geophysicists, Expanded Abstracts, pp. 1224-1227 (2002).

Pre-stack depth migration typically produces the best image images compared to the other type of migration. Pre-stack depth migration, however, is computationally intensive, and therefore relatively expensive, as compared with post-stack depth migration techniques. Pre-stack time migration techniques, such as the technique disclosed in the Sun et al. paper referred to above, are relatively computationally economical. What is needed is a technique to produce a stacked seismic section having the image quality of pre-stack depth migration while incurring pre-stack time migration computation cost.

Anisotropy is ubiquitously observed in many oil and gas exploration areas because of preferred ordering of minerals and defects related to stresses. In these regions, often the rock properties can be characterized as transversely isotropic (“TI”) media with either a vertical or tilted axis of symmetry. Wave propagation in anisotropic media exhibits different kinematics and dynamics from that in isotropic media, thus, it requires anisotropic modeling and migration methods to image reservoirs properly for oil and gas exploration.

Considering current art wave equation imaging in greater detail, the surface recorded seismic data can be grouped in different ways, for example, according to shots. In grouping according to shot, all seismic traces produced by a given shot are aggregated together into what is known as a common shot gather. As an alternative, seismic traces may be grouped according to receivers. That is all traces recorded by a surface receiver are aggregated together into a common receiver gather. As a third possibility, grouping according to offsets, all traces for which the shot-receiver separation falls within a specified range are aggregated together into a common offset gather. Each of the above types of data grouping, and other, similar possibilities, has its own imaging method, but the general imaging principles behind all methods are similar. For the sake of clarity and conciseness, the following discussion is limited to acoustic common shot imaging of surface recoded reflection data. The skilled person will appreciate how to apply the principles to the other methods.

Many algorithms exist for transforming the recorded seismic information into a geologically interpretable image. Since seismic data is typically observed (recorded) only at the surface of the earth, whereas the desired image is ideally a volume encompassing all of the interior of the earth that was illuminated by the seismic energy, central to all of these methods is a wavefield-extrapolation engine that computationally simulates the seismic waves propagating inside the earth from source to receiver. As is well known to those of ordinary skill in the art, the transmission, reflection, diffraction, etc., of seismic waves within the earth can be modeled with considerable accuracy by the wave equation, and accordingly wave-equation-based wavefield-extrapolation engines are the method of choice for difficult imaging problems. The wave equation is a partial differential equation that can readily be couched in terms of one, two, or three dimensions. For complex imaging challenges, the constant-density acoustic wave equation extrapolating in time is typically used as the extrapolation engine. Coupled with an imaging condition it yields an image of reflectors inside the earth. Imaging in this way is called “reverse-time migration”. The same extrapolation engine can also be used within an iterative optimization process that attempts to find an earth model that explains all of the seismic information recorded at the receivers. This is called “full-waveform inversion”. Ideally, inversion produces a 3-dimensional volume giving an estimated subsurface wave velocity at each illuminated point within the earth. If the acoustic wave equation is used, which incorporates both velocity and density as medium parameters, inversion may produce a 3-dimensional volume giving both the velocity and density at each point.

Rigorous solutions of wave equation are highly accurate in simulating wave propagation through complex subsurface regions. Downward continuation methods based on the one-way wave equation are well known for their computational efficiency and accuracy in handling multi-path events. Reverse-time migration (RTM) offers additional advantages over one-way imaging by removing the dip limitation and therefore is capable of handling wave propagation in any direction. Consequently a more complete set of waves (for example, prismatic waves, overturning waves and potentially multiples) can be used constructively for imaging challenging subsurface structures, such as steeply dipping or overhanging salt flanks Although becoming increasingly affordable, RTM is generally considered more computationally intensive than one-way downward continuation methods.

The high computational cost of RTM arises from solving the two-way wavefield propagation. For example, the source wavefield is propagated over time and saved to an electronic storage medium. As a result, RTM requires a significant storage space for reverse-time access of 3D source wavefields unless wavefield storage is traded with increased computation time. In RTM, in addition to the forward wavefield propagation, the seismic data are back extrapolated and correlated with the source wavefield. The runtime cost of RTM is thus approximately twice that of forward full-wavefield modeling.

Several prior art methods have been proposed to make RTM more efficient for practical applications in recent years. One prior art method shows that RTM is equivalent to Generalized Diffraction Stack Migration (GDM). A reduced version of GDM, called wavefront wave-equation migration, uses only first-arrival information to back-propagate arrivals. By introducing a square-root operator, another prior art method shows that the two-way wave equation can be formulated as a first-order partial differential equation (PDE) for cost-effective implementation. Yet another prior art method suggests target-oriented reverse time datuming (RTD) by extrapolating wavefields to a subsalt artificial datum using a finite-difference solver. Below the datum, a less intensive imaging method such as Kirchhoff migration can be used. Most recently, another prior art method showed test examples of target-oriented RTD. There, however, still exists a need for methods which perform RTM in less-costly computational ways.

### SUMMARY

One or more embodiments of the present disclosure provide a shot illumination compensation method implemented on a computer system for imaging a subsurface formation. The method includes receiving, by the computer system, seismic data produced by an acoustic energy source and reflected by the subsurface formation; and generating, by the computer system, an image of the subsurface formation based on the seismic data and a spatially varying damping parameter.

One or more embodiments of the present disclosure provide a computer system configured to implement a shot illumination method for imaging a subsurface formation. The computer system includes a memory configured to store seismic data produced by an acoustic energy source and reflected by the subsurface formation; and a processor configured to image subsurface formations based on the seismic data and a spatially varying damping parameter.

Yet, one or more embodiments of the present disclosure provide a computer-implemented shot illumination compensation system operable by a processor and arranged to process machine-readable instructions, that when executed cause the processor to image subsurface formations. The system includes an acoustic energy source configured to direct acoustic energy into a subsurface formation. The subsurface formation includes a formation having a steep dip. The system further includes a receiver configured to receive seismic data produced by the acoustic energy source and reflected by the subsurface formation; and a processor configured to process machine-readable instructions, that when executed cause the processor to image subsurface formations based on the seismic data and a spatially varying damping parameter.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various Figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 is an example of shot illumination method, according to an embodiment of the present invention;

FIG. 2A is an image obtained using a conventional method without illumination compensation on a subsurface formation;

FIG. 2B is an image obtained using a single shot illumination with illumination compensation method on the same subsurface formation, according to an embodiment of the present invention;

FIG. 3A is an image obtained using a conventional global illumination compensation method on a subsurface formation;

FIG. 3B is an image obtained using a single shot illumination with illumination compensation method on the same subsurface formation, according to an embodiment of the present invention;

FIG. 4 is flow chart of a shot illumination compensation method implemented on a computer system for imaging a subsurface formation, according to an embodiment of the present invention; and

FIG. 5 depicts a computer system configured to implement a shot illumination method for imaging a subsurface formation, according to an embodiment of the present invention.

### DETAILED DESCRIPTION

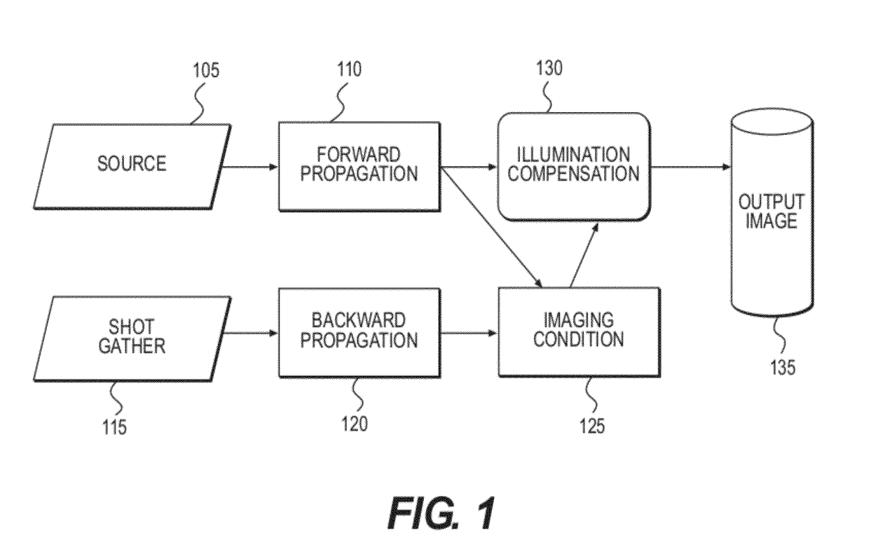

FIG. 1 is an example of shot illumination method, according to an embodiment of the present invention. A source of acoustic wave energy is arranged to direct acoustic energy into a rock formation, at 105. The acoustic energy is propagated in a forward direction toward the rock formation, at 110. At least a portion of the acoustic energy can be reflected, refracted or scattered by the rock formation. The reflected energy is received for a particular trigger event of the acoustic energy source as a shot gather, at 115. The shot gather includes recorded seismic data gathered by one or more receivers disposed at one or more of locations along a surface above a subsurface formation, for example, for one shot illumination. In order to transform the recorded seismic data into a geologically interpretable image, a backward propagation is performed at 120. Because seismic data is typically observed or recorded only at the surface of the earth, in order to provide an image of a volume encompassing all of the interior of the rock or subsurface formation that was illuminated by the seismic energy source, a wavefield-extrapolation engine using reverse-time migration (RTM) method can be used to computationally simulate the seismic waves propagating inside the earth from source to receiver.

The energy or signal represented by the shot gather propagates backward, at 120, with respect to the direction with which the acoustic energy was directed. Both the energy or wave signals in the forward and backward direction are input to an imaging condition module at 125. An illumination compensation module, at 130, receives the forward propagation signal or wave 110 and the imaging condition from 125 and outputs an image at 135.

A received wave signal or receiver wavefield R(x,y,z,t) depends on the down-going wave or source wavefield S(x,y,z,t) and the rock or subsurface formation image or reflectivity I(x,y,z). Specifically, a received wave signal or receiver wavefield R(x,y,z,t) is equal to a product of the down-going wave or source wavefield S(x,y,z,t) by the rock or subsurface formation image or reflectivity I(x,y,z) plus a noise component N(x,y,z,t). This can be expressed by the following equation (1).

R(x,y,z,t)=S(x,y,z,t)I(x,y,z)+N(x,y,z,t) (1)

In reverse time migration (RTM), zero-lag cross correlation between source wavefield and receiver wavefield is widely used as an imaging condition. This imaging condition is stable. A seismic migration imaging condition at any location of the Earth can be expressed as up-going wavefield (receiver wavefield) divided by down-going wave (source wavefield). The migrated image is a crude estimate of the reflectivity. However, this image condition also produces images that have low resolution. In addition, the image amplitudes are different from the reflection coefficient. Therefore, in order to normalize the images, the square of the source illumination strength is used instead of the source illumination strength. This is so-called illumination compensation.

Two major illumination compensation approaches can be used. One approach is the global illumination method and another approach is the shot-based illumination method. The illumination compensation for a single shot illumination or shot-based illumination can be expressed by the following equation (2). Equation (2) is a least-squares solution of equation (1).

$$I ( x , y , z ) = \frac{{\sum }_{t = 0}^{{t}_{max}} S ( x , y , z , t ) R ( x , y , z , t )}{{\sum }_{t = 0}^{{t}_{max}} {S}^{2} ( x , y , z , t )} \qquad ( 2 )$$

After performing the illumination compensation, the images represent the reflectivity and have the correct scaling and sign.

In global illumination, the final images are normalized by the sum of individual shot energy. This method is stable. However, this method cannot image steep dip. The global illumination compensation can be expressed by the following equation (3).

$$I ( x , y , z ) = \frac{{\sum }_{i = 1}^{N} {\sum }_{t = 0}^{{t}_{max}} S ( x , y , z , t ) R ( x , y , z , t )}{{\sum }_{i = 1}^{N} {\sum }_{t = 0}^{{t}_{max}} {S}^{2} ( x , y , z , t )} \qquad ( 3 )$$

The final image is normalized by the total or global illumination by summing over the total number of shots N. As a result, the global illumination compensation has a relatively high signal-to-noise ratio but is somewhat limited in imaging detailed subsurface formations such as steep dips.

On the other hand, shot-based or shot-by-shot-based illumination approach can image steep dips very well. Unfortunately, there is a stability issue for the shot illumination. Indeed, there is a stability issue in poorly illuminated zones, i.e., when the source illumination S(x,y,z,t) is very small or close to zero. This situation can appear, for example, when imaging steep dip features within the subsurface. In order to remedy this deficiency, a stable single shot illumination compensation method that is stable and can image steep dip is provided. This method uses a damped least-squares procedure which can be expressed by the following equation (4).

$$I ( x , y , z ) = \frac{{\sum }_{t = 0}^{{t}_{max}} S ( x , y , z , t ) R ( x , y , z , t )}{{\sum }_{t = 0}^{{t}_{max}} {S}^{2} ( x , y , z , t ) + ɛ ( x , y , z )} \qquad ( 4 )$$

where ε is a slowly varying function or parameter of space.

In one embodiment, a data-adaptive approach is proposed for generating ε. The slowly varying function or parameter of space can be expressed by the following equation (5).

ε=max{α,μmax(S²(x,y,z))} (5)

where μ is the inverse of signal-to-noise ratio and α is a small constant, for example, between 10⁻²⁰ and 10⁻¹⁵.

As is well known to those skilled in the art, the dip, location and character of a reflector on an unmigrated seismic section is rarely representative of the true dip, subsurface location and character of the structural or stratigraphic feature that gave rise to that reflector. Except in the case where the subsurface consists of homogenous, horizontal layers, the recorded seismic expression of a structural or stratigraphic event must be migrated before it can be reliably used to locate subsurface features of interest. In areas of steep dip, a reflection that is apparently located directly below a particular surface point before migration may, after migration, actually be found several hundreds of meters away. Additionally, in complex structural areas where faulting, severe asymmetrical folding and sharp synclines are present, diffractions and multiple reflections may interfere with reflections from the primary reflectors to the point where, without migration, the resulting seismic section bears little or no resemblance to the actual subsurface structure.

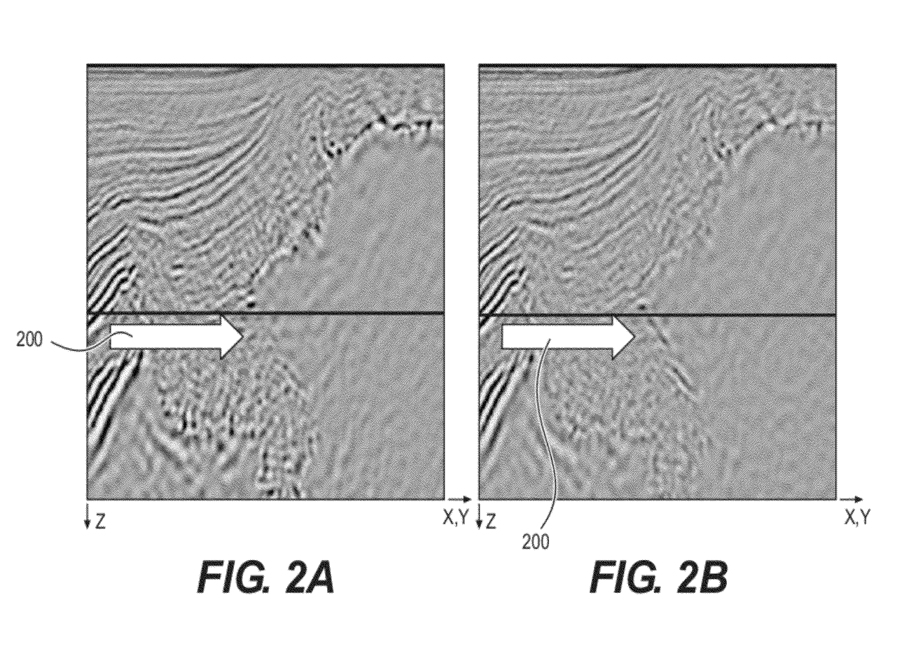

FIG. 2A is an image obtained using a conventional method without illumination compensation on a subsurface formation. FIG. 2B is an image obtained using a single shot illumination with illumination compensation method on the same subsurface formation, according to an embodiment of the present invention. The vertical axis in FIGS. 2A and 2B represents the Z-direction or the depth direction and the horizontal axis in FIGS. 2A and 2B represents the along the surface direction (e.g., X-direction or Y-direction). As generally indicated by arrow 200, the steep deep salt flank that is present in the subsurface formation is clearly imaged by the shot illumination method (FIG. 2B) while the steep deep salt flank that is present in the subsurface formation is not clearly imaged by the method without illumination. Indeed, in FIG. 2B, there is a clear darker steep line that indicates the presence of a steep deep salt formation where the arrow 200 points to.

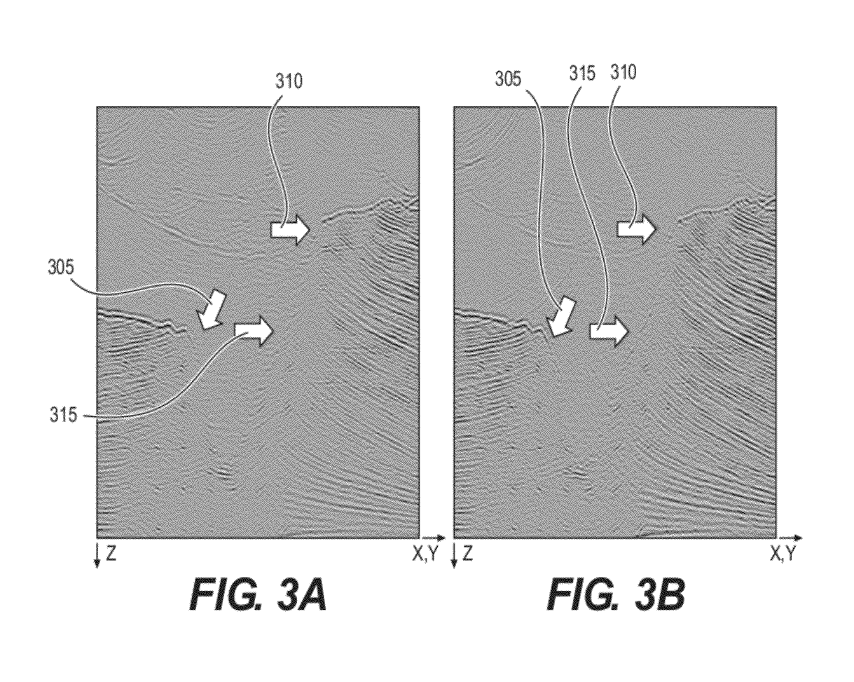

FIG. 3A is an image obtained using a conventional global illumination compensation method on a subsurface formation. FIG. 3B is an image obtained using a single shot illumination with illumination compensation method on the same subsurface formation, according to an embodiment of the present invention. The vertical axis in FIGS. 3A and 3B represents the Z-direction or the depth direction and the horizontal axis in FIGS. 3A and 3B represents the along the surface direction (e.g., X-direction or Y-direction). As generally indicated by arrows 305, 310 and 315, the steep deep salt flank that is present in the subsurface formation is clearly imaged by the shot illumination method (FIG. 3B) whereas the steep deep salt flank that is present in the subsurface formation is not clearly imaged by the global illumination method. Indeed, in FIG. 3B, there is a clear darker steep demarcation line that indicates the presence of a steep deep salt formation where the arrows 305, 310 and 315 point to.

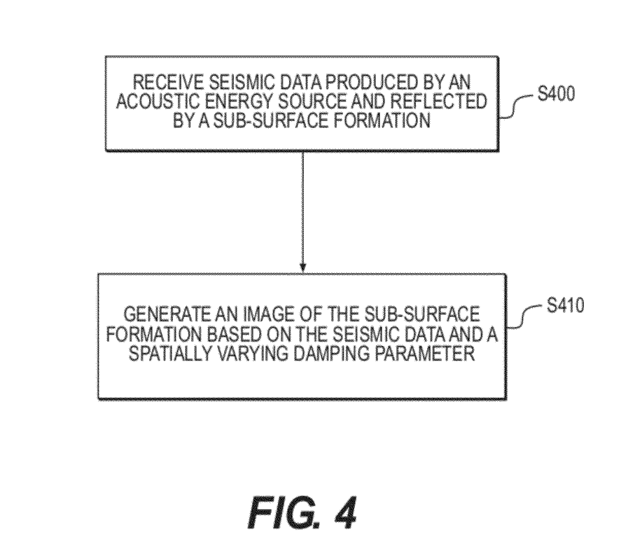

FIG. 4 is flow chart of a shot illumination compensation method implemented on a computer system for imaging a subsurface formation, according to an embodiment of the present invention. The method includes receiving, by the computer system, seismic data produced by an acoustic energy source and reflected by the subsurface formation, at S400. The method further includes generating, by the computer system, an image of the subsurface formation based on the seismic data and a spatially varying damping parameter, at S410.

In one embodiment, the seismic data includes a plurality of shot gathers corresponding to data gathered by one or more receivers disposed at one or more locations on a surface above the subsurface formation. In one embodiment, the generating of the image comprises utilizing a reverse time migration or a wave-equation based shot migration. In one embodiment, the spatially varying damping parameter is based on a square of a source wavefield, an inverse of a signal-to-noise ratio and a constant parameter. In one embodiment, the constant parameter is between 10⁻¹⁵ and 10⁻²⁰. In one embodiment, the constant parameter stabilizes the image for near-zero source wavefield conditions. In one embodiment, the subsurface formation comprises a tilted transverse isotropic formation. In one embodiment, the damping parameter is arranged to compensate for steep dips in the subsurface formation.

In one embodiment, a computer program product having a computer readable medium having instructions stored thereon when executed by the computer system performs the illumination compensation method describe in the above paragraphs. Alternatively, instead or in addition to implementing the methods described above as computer program product(s) (e.g., as software products) embodied in a computer, the method described above can be implemented as hardware in which for example an application specific integrated circuit (ASIC) can be designed to implement the method or methods of the present invention.

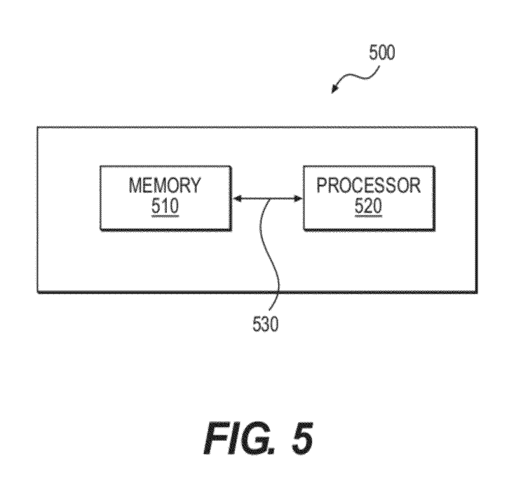

FIG. 5 depicts a computer system configured to implement a shot illumination method for imaging a subsurface formation, according to an embodiment of the present invention. The computer system 500 comprises a memory 510 and a processor 520. The memory 510 is configured to store seismic data produced by an acoustic energy source and reflected by the subsurface formation. The processor 520 is in communication with memory 510 through communication link 530. The processor 520 is configured to image subsurface formations based on the seismic data and a spatially varying damping parameter. For example, the seismic data can be communicated from memory 510 to processor 520 via link 530. In one embodiment, the spatially varying damping parameter can be provided by selecting and inputting appropriate constant α parameter between 10⁻²⁰ and 10⁻¹⁵. The term “processor” used herein refers to one or more processors. The term “memory” used herein refers to one or more storage devices. In one embodiment, the computer system 500 can be a stand-alone personal computer, a laptop computer, a hand-held or portable computer, a mainframe computer, a server computer, or a computer system in a distributed computing environment using a plurality of computers.

In one embodiment, the seismic data includes a plurality of shot gathers corresponding to data gathered by one or more receivers disposed at one or more locations on a surface above the subsurface formation. In one embodiment, the processor is further configured to generate the image using a reverse time migration or a wave-equation based shot migration. In one embodiment, the damping parameter is based on a square of a source wavefield, an inverse of a signal-to-noise ratio and a constant parameter. In one embodiment, the constant parameter is between 10⁻¹⁵ and 10⁻²⁰. In one embodiment, the constant parameter stabilizes the image for near-zero source wavefield conditions. In one embodiment, the subsurface formation comprises a tilted transverse isotropic formation. In one embodiment, the damping parameter is configured to compensate for steep dips in the subsurface formation.

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. As a further example, it is to be understood that the present invention contemplates that, to the extent possible, one or more features of any embodiment can be combined with one or more features of any other embodiment.

What is claimed is:

1. A shot illumination compensation method implemented on a computer system for imaging a subsurface formation, the method comprising:
receiving, by the computer system, seismic data produced by an acoustic energy source and reflected by the subsurface formation; and
generating, by the computer system, an image of the subsurface formation based on the seismic data and a spatially varying damping parameter.

2. The method according to claim 1, wherein the seismic data includes a plurality of shot gathers corresponding to data gathered by one or more receivers disposed at one or more locations on a surface above the subsurface formation.

3. The method according to claim 1, wherein the generating of the image comprises utilizing a reverse time migration or a wave-equation based shot migration.

4. The method according to claim 2, wherein the spatially varying damping parameter is based on a square of a source wavefield, an inverse of a signal-to-noise ratio and a constant parameter.

5. The method according to claim 4, wherein the constant parameter is between 10⁻¹⁵ and 10⁻²⁰.

6. The method according to claim 4, wherein the constant parameter stabilizes the image for near-zero source wavefield conditions.

7. The method according to claim 4, wherein the subsurface formation comprises a tilted transverse isotropic formation.

8. The method according to claim 1, wherein the damping parameter is arranged to compensate for steep dips in the subsurface formation.

9. A computer program product comprising a computer readable medium having instructions stored thereon when executed by the computer system performs the method of claim 1.

10. A computer system configured to implement a shot illumination method for imaging a subsurface formation, the computer system comprising:
a memory configured to store seismic data produced by an acoustic energy source and reflected by the subsurface formation; and
a processor configured to image subsurface formations based on the seismic data and a spatially varying damping parameter.

11. The computer system according to claim 10, wherein the seismic data includes a plurality of shot gathers corresponding to data gathered by one or more receivers disposed at one or more locations on a surface above the subsurface formation.

12. The computer system according to claim 10, wherein the processor is further configured to generate the image using a reverse time migration or a wave-equation based shot migration.

13. The computer system according to claim 11, wherein the damping parameter is based on a square of a source wavefield, an inverse of a signal-to-noise ratio and a constant parameter.

14. The computer system according to claim 13, wherein the constant parameter is between 10⁻¹⁵ and 10⁻²⁰.

15. The computer system according to claim 13, wherein the constant parameter stabilizes the image for near-zero source wavefield conditions.

16. The computer system according to claim 13, wherein the subsurface formation comprises a tilted transverse isotropic formation.

17. The computer system according to claim 10, wherein the damping parameter is configured to compensate for steep dips in the subsurface formation.

18. A computer-implemented shot illumination compensation system operable by a processor and arranged to process machine-readable instructions, that when executed cause the processor to image subsurface formations, the system comprising:
an acoustic energy source configured to direct acoustic energy into a subsurface formation, wherein the subsurface formation includes a formation having a steep dip;
a receiver configured to receive seismic data produced by the acoustic energy source and reflected by the subsurface formation; and
a processor configured to process machine-readable instructions, that when executed cause the processor to image subsurface formations based on the seismic data and a spatially varying damping parameter.

19. The computer-implemented system according to claim 18, wherein the processor is further configured to generate the image using a reverse time migration or a wave-equation based shot migration.

20. The computer-implemented system according to claim 18, wherein the subsurface formation comprises a tilted transverse isotropic formation.

21. The computer-implemented system according to claim 18, wherein the damping parameter is based on a square of a source wavefield, an inverse of a signal-to-noise ratio and a constant parameter.
